(19) United States
(12) Patent Application Publication
(10) Pub. No.: US 2015/0261853 A1
(43) Pub. Date: Sep. 17, 2015

(54) Method And Device For Displaying And Adding Comments On Webpage Contents

(71) Applicant: TENCENT TECHNOLOGY (SHENZHEN) COMPANY LIMITED, Shenzhen City (CN)

(72) Inventor: Heming SHAO, Shenzhen (CN)

(21) Appl. No.: 14/722,499

(22) Filed: May 27, 2015

Related U.S. Application Data
(63) Continuation of application No. PCT/CN2013/086669, filed on Nov. 7, 2013.

(30) Foreign Application Priority Data
Dec. 3, 2012 (CN) 201210508844.8

(51) Int. Cl. G06F 17/30

(52) U.S. Cl. CPC G06F 17/30716; G06F 17/30554; G06F 17/30864; G06F 17/30268

(57) ABSTRACT

Methods and device for displaying and adding comments on webpage content are described. Webpage content corresponding to comment may be highlighted. A display instruction may be received. The display instruction may correspond to the webpage content corresponding to the comment. The comment may be displayed according to the display instruction.

### CROSS-REFERENCE TO RELATED APPLICATIONS

This application is a continuation of International Application No. PCT/CN2013/086669, filed Nov. 7, 2013. This application claims the benefit and priority of Chinese Application No. 201210508844.8, filed Dec. 3, 2012. The entire disclosures of each of the above applications are incorporated herein by reference.

### FIELD

The present disclosure relates to a method and device for displaying and adding comments on webpage content.

### BACKGROUND

This section provides background information related to the present disclosure which is not necessarily prior art.

Presently, along with the continuous development of network communication technologies, a user may conveniently surf the Internet and may comment or view relevant comments on webpage content (such as, news, blogs, news and information and various other content).

### SUMMARY

This section provides a general summary of the disclosure, and is not a comprehensive disclosure of its full scope or all of its features.

According to various embodiments, a method and device for displaying webpage content may be provided to enhance processing speed and efficiency of the comments.

A method for displaying a comment on webpage content includes: highlighting webpage content corresponding to a comment;

receiving a display instruction, wherein the display instruction corresponds to the webpage content corresponding to the comment; and

displaying the comment according to the display instruction.

A method for adding a comment on webpage content includes: receiving a first selection instruction;

obtaining webpage content corresponding to the first selection instruction; prompting a user to add a comment on the webpage content corresponding to the first selection instruction;

receiving the comment made by the user on the webpage content corresponding to the first selection instruction; and adding the comment to the webpage content corresponding to the first selection instruction.

A device for displaying a comment on webpage content includes:

a first webpage content highlighting module, to highlight webpage content corresponding to a comment;

a first display instruction receiving module, receiving a display instruction; wherein the display instruction corresponds to the webpage content corresponding to the comment; and

a first comments displaying module, to display the comment according to the display instruction.

A portion of the webpage content may be selected by the client terminal device and comments may be made on a portion of the webpage content in time, instead of behind the webpage content. When the comments on the webpage content are viewed, the relevant comments may be automatically visible. Therefore, a sentence or a view of point may be automatically viewed, so that comment may be more visible and the user may quickly find the comment. In addition, it may be easier to manage the comment, by which the speed for viewing the webpage content may be not affected and the processing speed of the comment may be enhanced. The comment may include the picture comment or video comment in addition to the text comment, which may enlarge the application scope of the comment.

Further areas of applicability will become apparent from the description provided herein. The description and specific examples in this summary are intended for purposes of illustration and are not intended to limit the scope of the present disclosure.

### DRAWINGS

The drawings described herein are for illustrative purposes of various embodiments and not all possible implementations, and are not intended to limit the scope of the present disclosure.

FIG. 1A is a flowchart illustrating a method for displaying comments on webpage content according to various embodiments;

FIG. 1B is a flowchart illustrating another method for displaying comments on webpage content according to various embodiments;

FIG. 2 is a diagram illustrating a device for displaying comments on webpage content according to various embodiments;

FIG. 3A is a flowchart illustrating another method for displaying comments on webpage content according to various embodiments;

FIGS. 3B to 3E are pictures generated in the method for displaying comments on webpage content shown in FIG. 3A;

FIG. 4 is a flowchart illustrating another method for displaying comments on webpage content according to various embodiments;

FIG. 5 is a flowchart illustrating a method for adding comments to webpage content according to various embodiments;

FIG. 6 is a diagram illustrating a device for adding comments to webpage content according to various embodiments;

FIG. 7 is a diagram illustrating another device for displaying comments on webpage content according to various embodiments; and

FIG. 8 is a diagram illustrating another device for adding comments to webpage content according to various embodiments.

Corresponding reference numerals indicate corresponding parts throughout the several views of the drawings.

### DETAILED DESCRIPTION

Various embodiments will now be described more fully with reference to the accompanying drawings.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

According to various embodiments, the method for commenting on webpage content may include opening a webpage, viewing information on the webpage, inputting comments on the webpage content into an input box if a user wishes to comment on the webpage content, and clicking on “submit comments”. Relevant comments may be displayed behind the webpage content. Since the comments may be added behind the webpage content, the processing speed of the comments may be reduced and the viewing speed of the webpage content may also be affected. In addition, the comments may be not visible and may be inconvenient for management. Various embodiments may provide a method and device for displaying comments on the webpage content to make comments on the webpage content in time and intuitively display relevant comments, by which the processing speed and management efficiency of the comments may be enhanced.

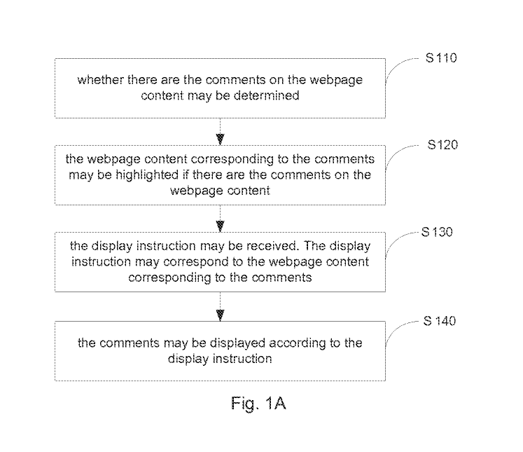

FIG. 1A is a flowchart illustrating a method for displaying comments on webpage content according to various embodiments. The method may be implemented via a displaying terminal device. The method may include the following blocks.

Block S110: Whether there are comments on webpage content is determined.

Block S120: Webpage content corresponding to the comments are highlighted if there are the comments on the webpage content.

In the above blocks S110 and S120, various embodiments may omit block S110.

Block S130: A display instruction is received. The display instruction may correspond to the webpage content corresponding to the comments.

Block S140: The comments are displayed according to the display instruction.

In the above block S110, whether there are the comments on the webpage content is determined. That is, a display terminal device may determine whether there are the comments on the currently-displayed webpage content. The webpage content mentioned in the above block S110 may be whole content of a piece of news, a blog or a log.

In the above block S120, the webpage content corresponding to the comments is highlighted if there are the comments on the webpage content. According to various embodiments, if there are the comments on the partial webpage content (i.e., selected webpage content, which may be the webpage content corresponding to the comments), the webpage content corresponding to the comments may be highlighted. The comments may be more visible so the user may quickly find the comments.

If the selected webpage content is commented on many times and the comments corresponding to the selected webpage content are folded, an icon including a number may be displayed on the upper right corner of the selected webpage content. The icon may be used for indicating how many times the selected webpage content is commented on, through which the efficiency for managing the comments may be enhanced.

In the above S130, the display instruction is received. The display instruction may correspond to the webpage content corresponding to the comments. According to various embodiments, the highlighted webpage content may be selected on the display terminal device.

In the above block S140, the comments are displayed according to the display instruction. According to various embodiments, after the display terminal device receives the display instruction, the comments may be unfolded and displayed on the display terminal device, so that the user and other readers may view the comments. Therefore, through the technical scheme in the above example, the comments and references may be more visible so that the user may quickly view the comments, which may enhance the management efficiency of the comments.

FIG. 1B is a flowchart illustrating another method for displaying comments on webpage content according to various embodiments. In other examples, before the above block S110, the method for displaying the webpage content may further include the following blocks.

Block S101: The webpage content is displayed.

Block S102: A first selection instruction is received and webpage content corresponding to the first selection instruction may be obtained.

Block S103: An operation option interface is displayed. The operation option interface may include a comment operation.

Block S104: A second selection instruction is received and whether the received second selection instruction corresponds to the comment operation may be determined. A comment window may be further displayed if the second selection instruction corresponds to the comment operation. The comment window may be used for receiving the comments.

Block S105: The comments on the webpage content corresponding to the first selection instruction are received.

Block S106: The comments are added to the webpage content corresponding to the first selection instruction.

In the above block S101, the webpage content is displayed. The webpage content (such as a piece of news, a blog, or other various content) may be displayed on the display terminal device.

In the above block S102, the first selection instruction is received and the webpage content corresponding to the first selection instruction may be obtained. If a user wishes to make comments on a sentence or a point of view in the above webpage content, the user may need to select a portion of the webpage content corresponding to the sentence or the point of view. The display terminal device may obtain the webpage content corresponding to the first selection instruction (i.e., the selected webpage content).

In the above block S103, the operation option interface is displayed. The operation option interface may include the comment operation. The display terminal device may send the operation option interface to the scope of the selected webpage content. The display terminal device may be a PC, an intelligent phone, a mobile terminal device or a tablet PC. The operation option interface may be displayed on a display interface of the display terminal device in a form of an operation selection box. The operation option interface may include a copy operation, a search operation, and a comment operation. With the copy operation, the selected webpage content may be copied. With the search operation, the selected webpage content may be searched. With the comment operation, the selected webpage content may be commented.

In the above S104, a second selection instruction is received. Whether the second selection instruction may correspond to the comment operation may be determined. If the second selection instruction corresponds to the comment operation, a comment window may be further displayed. The comment window may be used for receiving the comments. After the display terminal device receives the second selection instruction, the display terminal device may determine whether the second selection instruction is the comment operation and send a comment request if the second selection instruction is the comment operation. If the second selection operation is the copy operation or the search operation, the display terminal device may do other processing. If the second selection instruction is the comment operation, the display window may be displayed on the display terminal device, so the user may comment on the selected webpage content.

In the above block S105, the comments corresponding to the selected webpage content (i.e., the webpage content corresponding to the first selection instruction) are received. Relevant comments on the selected webpage content may be received. The comments may include at least one of text comments, picture comments, and video comments. The picture comments may be Emoticons or appreciated gestures, etc. The video comments may be a video lasting several minutes. The comments may also be the combination of the text comments, the picture comments, and the video comments rendering the comments more animated.

In the above block S106, the comments are added to the selected webpage content. After the display terminal device receives the comments, the comments may be saved in a database so that the comments may be viewed on the display terminal device when the webpage content is viewed. The comments may be displayed in a sidebar (such as comments) on a display interface of the display terminal device. The comments may be displayed on the right of the selected webpage content, which does not affect the speed for viewing the webpage content. The comments may be relevantly visible and it may be easier to manage the comments. When the user clicks the selected webpage content via the display terminal device, the comments corresponding to the selected webpage content may be folded and the selected webpage content may be highlighted.

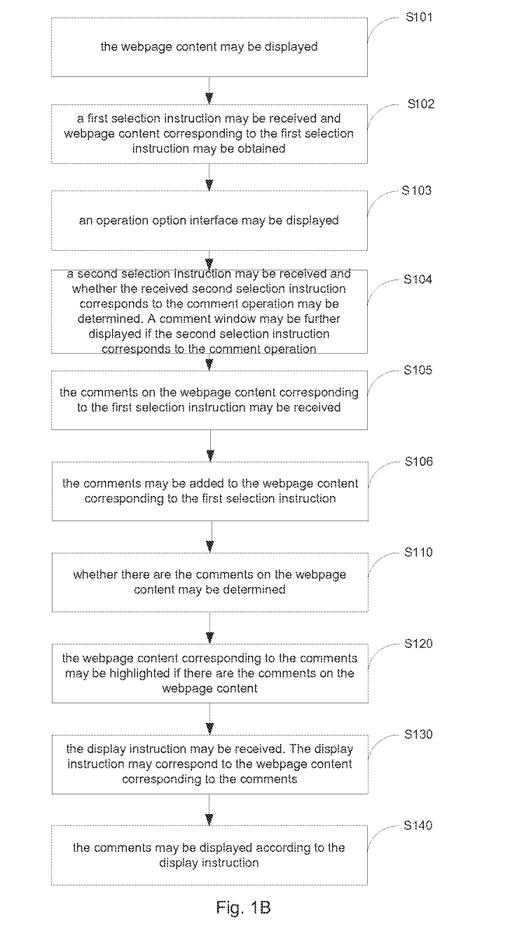

An example of a device for displaying comments on webpage content may be described hereinafter accompanying FIG. 2. The device may be set in a display terminal device. The device may include a first webpage content highlighting module M221, a first display instruction receiving module M222, and a first comments displaying module M223. According to various embodiments, the device may further include a first comments determination module M220. The first comments determination module M220 may determine whether there are comments on webpage content. The first webpage content highlighting module M221 may highlight webpage content corresponding to the comments if there are the comments on the webpage content. The first display instruction receiving module M222 may receive a display instruction. The display instruction may correspond to the webpage content corresponding to the comments. The first comments display module M223 may display the comments according to the display instruction.

The first comments determination module M220 may be set in the display terminal device and may determine whether there are comments in the currently-displayed webpage content.

The first webpage content highlighting module M221 may be set in the display terminal device and may connect with the first comments determination module M220. If there are comments on selected webpage content in the currently-displayed webpage content, the webpage content corresponding to the comments may be highlighted so that the comments may be displayed in time and may be more visible. If the selected webpage content (i.e. the webpage contents corresponding to the comments) is commented on many times, when the comments corresponding to the selected webpage content are folded, an icon including a number may be displayed on the upper right corner of the selected webpage content and the icon may be used for indicating how many times the selected webpage content are commented on, through which the efficiency for managing the comments may be enhanced.

The first display instruction receiving module M222 may be set in the display terminal device and may connect with the first webpage content highlighting module M221.

The first comments display module M223 may be set in the display terminal device and may connect with the first display instruction receiving module M222. After the display instruction is received by the display terminal device, the first comments display module M223 may unfold the comments and display the comments on the display terminal device so that the user and other readers may view the comments. Therefore, this device may not only make the comments and reference contents more visible and accurate, but it may also enhance the efficiency for managing the comments.

According to various embodiments, the device may further include a first webpage content displaying module M211, a first selection instruction receiving module M212, a first operation option displaying module M213, a first operation instruction determination module M214, a first comments receiving module M215, and a first comments adding module M216. The first webpage content displaying module M211 may display the webpage content. The first selection instruction receiving module M212 may receive a first selection instruction and obtain webpage content corresponding to the first selection instruction. The first operation option displaying module M213 may display an operation option interface. The first operation instruction determination module M214 may receive a second selection instruction, determining whether the second selection instruction corresponds to a comment operation, and displaying a comment window if the second selection instruction corresponds to the comment operation. The comment window may be used for receiving the comments. The first comments receiving module M215 may receive the comments corresponding to the webpage content. The first comments adding module M216 may add the comments to the webpage content corresponding to the comments.

The first webpage content displaying module M211 may be set on the display terminal device. The webpage content (such as, news, a blog, information and other various content) may be viewed via the display terminal device.

The first selection instruction receiving module M212 may be set on the display terminal device and may connect with the first webpage content displaying module M211. If a user wishes to make comments on a sentence or a point of view on the webpage content, a portion of the webpage content may be selected. The display terminal device may obtain the webpage content corresponding to the first selection instruction (i.e., the selected webpage content). The obtaining operation may be implemented via the first selection instruction receiving module M212.

The first operation option displaying module M213 may be set on the display terminal device and connect with the first selection instruction receiving module M212. The first operation option displaying module 213 may display the operation option interface. The display terminal device may send the operation option interface to the selected webpage content. The display terminal device may be any of a PC, an intelligent mobile phone, a mobile terminal device, and a tablet PC. The operation option interface may be displayed on a display interface of the display terminal in the form of an operation selection box. The operation options may include a copy operation, a search operation, and a comment operation. With the copy operation, the selected webpage content may be copied. With the search operation, the selected webpage content may be searched. With the comment operation, the selected webpage content may be commented. The above operations may be implemented with the above first operation option displaying module M213.

The first operation instruction determination module M214 may be set in the display terminal device and may connect with the operation option displaying module M213. The first operation instruction determination module M214 may receive a second selection instruction, determine whether the second selection instruction corresponds to the comment operation, and display the comment window if the second selection instruction corresponds to the comment operation. After the display terminal device receives the second selection instruction, the display terminal device may determine whether the second selection instruction is the comment operation. The display terminal device may send a comment request if the second selection instruction is the comment operation. If the second selection instruction is the copy operation or the search operation, the display terminal device may perform other corresponding operations. After the first operation instruction determination module M214 determines that the second selection instruction is the comment operation, the comment window may be displayed on the display terminal device, so that the user may comment on the selected webpage content.

The first comments receiving module M215 may be set in the display terminal device and connect with the first operation instruction determination module M214. The first comments receiving module M215 may receive the relevant comments on the selected webpage content. The comments may include any of the text comments, picture comments, and video comments. The picture comments may be Emoticons or appreciated gestures, etc. The video comments may be a video lasting several minutes. The comments may also be the combination of the text comments, the picture comments, and the video comments rendering the comments more animated.

The first comments adding module M216 may be set in the display terminal device and may connect with the first comments receiving module M215. The first comments adding module M216 may add the comments to the selected webpage content and display the comments in a sidebar (such as comments). After the display terminal device receives the comments, the comments may be saved in the database, so that the comments may be viewed on the display terminal device. On the display interface of the display terminal device, the comments may be displayed in the sidebar (such as the comments). The comments may be displayed on the right of the selected webpage content, which does not affect the speed for viewing the webpage content. The comments may be relevantly visible and it may be easier to manage the comments.

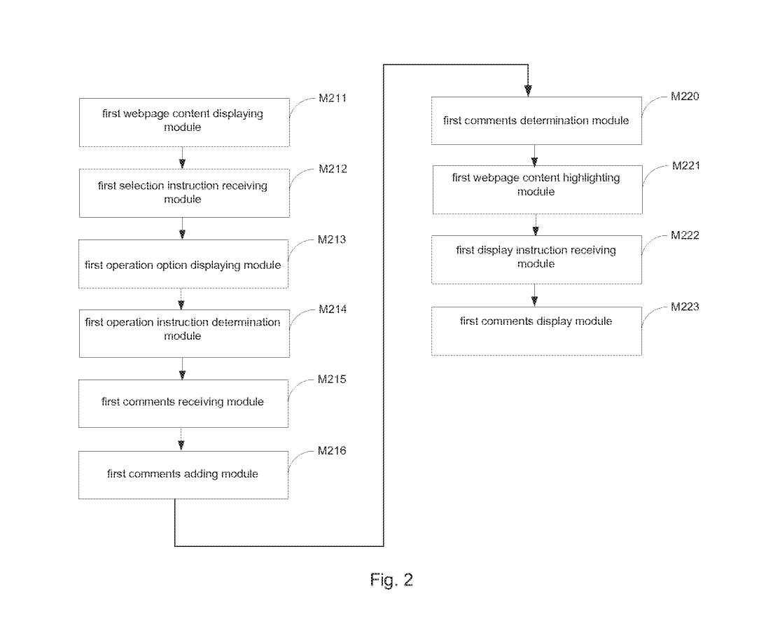

FIG. 3A is a flowchart illustrating another method for displaying comments on webpage content according to various embodiments.

This example may be described hereinafter as viewing a piece of news on the display terminal device of a PC for example. Content of this piece of news may be “In a recently-published article of astrophysics bulletin in a complicated transition process from frozen organic matters to slime molds . . . the process for transiting the frozen organic matters to ‘pre-biotic’ may be implemented”.

Block S311: Webpage content is displayed. News may be displayed on the PC.

Block S312: A first selection instruction is received and webpage content corresponding to the first selection instruction is obtained. If comments are to be made on a sentence (such as, a sentence A, i.e. “from the frozen organic matters to the slime molds”) in the news, the sentence A on the display terminal device may be selected on the PC. The PC may receive the selected sentence A.

Block S313: An operation option interface is displayed. The operation option interface may include a comment operation. The PC may send the operation option interface to the selected sentence A. The operation option interface may be displayed on the display interface of the display terminal device of the PC (as shown in FIG. 3B) in the form of an operation selection box. The operation options sent by the PC may include the copy operation, the search operation, and the comment operation. With the comment operation, comments may be made on the selected sentence A.

Block 314: A second selection instruction is received and whether the second selection instruction is the comment operation may be determined. A comment window may be displayed if the second selection instruction is the comment operation and the comment window may be used for receiving the comments. After the PC receives the second selection instruction and determines that the second selection instruction is the comment operation, the PC sends a comment request. The comment window may be displayed on the display interface of the PC so that the user may make comments on the sentence A (referring to FIG. 3C, for example, the user may input the comments “What does this sentence mean?”).

Block S315: The comments corresponding to the selected webpage content are received. The relevant comments on the selected webpage content may be received. The comments are text comments made by the user on this sentence (i.e. sentence A) in this news.

Block S316: On the display interface of the PC, the comments are added to the webpage content. After receiving the comments, the PC may save the comments into the database so that the user or other readers may directly view the comments on the display interface of the PC if the user and the other readers view this sentence (i.e. sentence A) in the news. On the display interface of the PC, the comments (referring to FIG. 3D) may be displayed in the sidebar (such as the comments). The comments may be displayed on the right of the sentence A, which does not affect the speed for viewing the webpage content. The comments may be relevantly visible and it may be easier to manage the comments.

Block S320: Whether there are comments on the webpage content is determined. The display terminal device may detect and determine whether there are comments on the webpage content.

Block S321: If there are comments on the webpage content, the webpage content corresponding to the comments is highlighted. If the display terminal device may detect that there are comments on the webpage content, the webpage content corresponding to the comments may be highlighted. If the sentence A relating to the comments may be commented on several times and all the comments corresponding to the sentence A may be folded, an icon including a number may be displayed on the upper right corner of the sentence A, and the icon may be used for indicating how many times the sentence A are commented on (referring to FIG. 3E). For instance, the number is 3, which may indicate that the sentence A has been commented on 3 times and may make the comments more visible and simpler to manage.

Block S322: A display instruction is received. The display instruction that may correspond to the selected webpage content corresponding to the comments may be added.

Block S323: The comments are displayed according to the display instruction. After the display terminal device receives the display instruction, the folded commented may be unfolded and displayed on the display terminal device so that the user and other readers may view the comments. Therefore, this method may not only make the comments and reference contents more visible and accurate, but also enhance the efficiency for managing the comments.

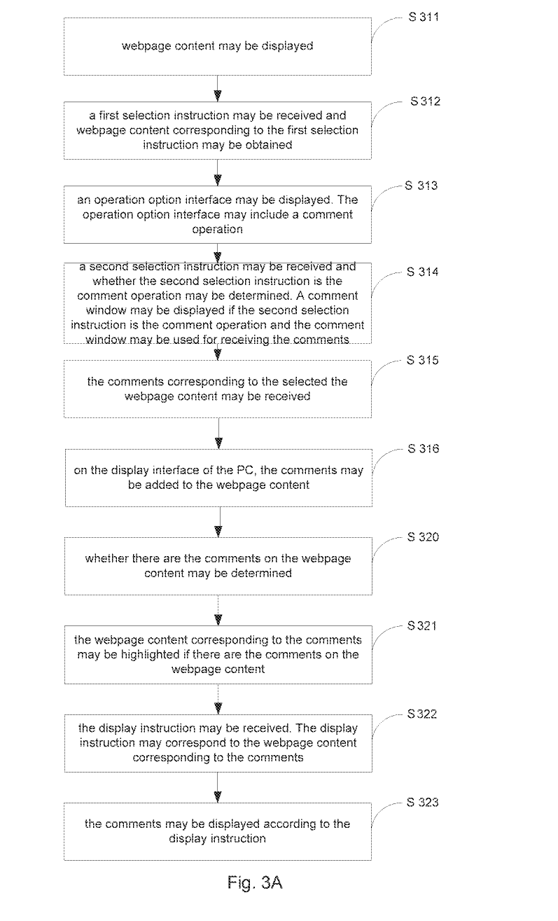

FIG. 4 is a flowchart illustrating another method for displaying comments on webpage content according to various embodiments. This example is described hereinafter as viewing blogs with the display terminal device on the intelligent phone for example.

Block S411: Webpage content is displayed. Blogs may be displayed on the intelligent phone.

Block S412: A first selection instruction is received and webpage content corresponding to the first selection instruction may be obtained. If comments are to be made on a point of view (such as a sentence B) in a blog, the sentence B may be selected on the display interface of the intelligent phone. The intelligent phone may receive the selected sentence B.

Block S413: An operation option interface is displayed. The operation option interface may include a comment operation. The intelligent phone may send the operation option interface to the selected sentence A. The operation option interface may be displayed on the display interface of the intelligent phone in a form of an operation selection box. The operation options sent by the intelligent phone may include the copy operation, the search operation, and the comment operation. With the comment operation, comments may be made on the selected sentence B.

Block 414: A second selection instruction is received and whether the second selection instruction is the comment operation may be determined. A comment window may be displayed if the second selection instruction is the comment operation and the comment window may be used for receiving the comments. After the intelligent phone receives the second selection instruction and determines that the second selection instruction is the comment operation, the intelligent phone sends a comment request. The comment window may be displayed on the display interface of the intelligent phone so that the user may make comments on the sentence B.

Block S415: The comments on the webpage content corresponding to the first selection instruction are received. The relevant comments on the selected webpage content may be received. The comments are a combination of the text comments and picture comments made by the user on the user's point of view (i.e. sentence B) in this blog.

Block S416: On the display interface of the intelligent phone, the comments may be added to the webpage content corresponding to the first selection instruction. After receiving the comments, the intelligent phone may save the comments into the database so that the user or other readers may directly view the comments on the display interface of the intelligent phone if the user and the other readers see this view point (i.e. sentence B) in the blog. On the display interface of the intelligent phone, the comments may be displayed in the sidebar (such as the comments). The comments may be displayed on the right of the sentence B, which does not affect the speed for viewing the webpage content. The comments may be relevantly visible and it may be easier to manage the comments.

Block S420: Whether there are comments on the webpage content is determined. The display terminal device may detect and determine whether there are comments on the webpage content.

Block S421: If there are comments on the webpage content, the webpage content corresponding to the comments is highlighted. If the display terminal device detects that there are comments on the webpage content, the webpage content corresponding to the comments may be highlighted. If the sentence B relating to the comments are commented on several times and all the comments corresponding to the sentence B may be folded up, an icon including a number may be displayed on the upper right corner of the sentence B, and the icon may be used for indicating how many times the sentence B (this point of view) are commented on. For instance, the number is 1, which may indicate that the sentence B has been commented on once.

Block S422: a display instruction is received. The display instruction may correspond to the webpage content corresponding to the comments.

Block S423: The comments are displayed according to the display instruction. After the display terminal device receives the display instruction, the folded commented may be unfolded and displayed on the display terminal device so that the user and other readers may view the comments. Therefore, this method may not only make the comments and reference content more visible and accurate, but also enhance the efficiency for managing the comments.

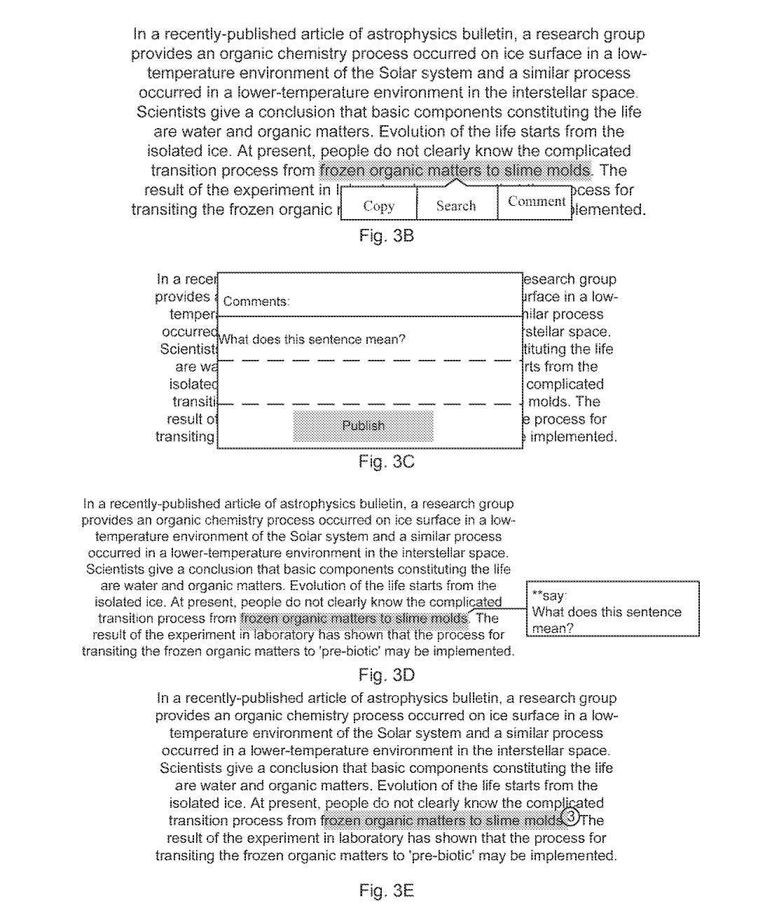

FIG. 5 is a flowchart illustrating a method for adding comments on webpage content according to various embodiments. The method may be implemented via a display terminal device. The method may include the following blocks. In block S510, a first selection instruction is received and webpage content selected by a user may be obtained via the first selection instruction. In block S520, whether an operation for obtaining the selected webpage content is completed is determined. In block S530, if the operation for obtaining the selected webpage content is completed, the user may be prompted to add comments and the comments made by the user on the selected webpage content are received. In block S540, the webpage content corresponding to the comments is displayed.

In the above S510, the first selection instruction is received and the selected webpage content (i.e. the webpage content corresponding to the first selection instruction) selected by the user may be obtained according to the first selection instruction. If a user comments on a sentence or a point of view on the selected webpage content, the corresponding webpage content should be selected. The display terminal device may obtain the webpage content corresponding to the first selection instruction (i.e. the selected webpage content).

Block S520: Whether the operation for obtaining the selected webpage content is completed is determined. If the user selects a portion of the webpage content, the display terminal device may automatically detect whether the user has finished the operation for obtaining the selected webpage content. If the operation for obtaining the selected webpage content is not completed, the display terminal device may continue to receive the webpage content selected by the user. If the operation for obtaining the selected webpage content is completed, block S530 may be executed.

According to various embodiments, block S520 may be optional.

Block S530: If the operation for obtaining the selected webpage content is completed, the user is prompted to add the comments and the comments added by the user on the selected webpage content may be received.

Block S530: An operation option interface is displayed. The operation option interface may include a comment operation. The display terminal device may send the operation option interface to a scope of the selected webpage content. The display terminal device may be a PC, an intelligent phone, a mobile terminal device or a tablet PC. The operation option interface may be displayed on the display interface of the display terminal device in a form of an operation selection box. The operation options may include a copy operation, a search operation, and a comment operation. With the copy operation, the selected webpage content may be copied. With the search operation, the selected webpage content may be searched. With the comment operation, the selected webpage content may be commented.

A second selection instruction may be received and whether the second selection instruction corresponds to the comment operation may be determined. If the second selection instruction corresponds to the comment operation, a comment window may be further displayed. The comment window may be used for receiving the comments.

The display terminal device may receive the second selection instruction and determine whether the received second selection instruction corresponds to the comment operation. If the second selection instruction corresponds to the comment operation, the display terminal may send a comment request. After the display terminal device determines that the second selection instruction is the comment operation, the comment window may be displayed on the display terminal device so that the user may comment on the selected webpage content.

The display terminal device may add the comments on the selected webpage content. The display terminal device may receive the comments added on the selected webpage content. The comments may include any of the text comments, picture comments, and video comments. The picture comments may be Emoticons or appreciated gestures, etc. The video comments may be a video lasting several minutes. The comments may also be the combination of the text comments, the picture comments, and the video comments rendering the comments more animated.

Block S540: The webpage content corresponding to the comments is displayed. After the comments on the selected webpage content are received, on the display interface of the display terminal device, the comments may be displayed in the sidebar (such as the comments). The comments may be displayed on the right of the selected webpage content, which does not affect the speed for viewing the webpage content. The comments may be relevantly visible and it may be easier to manage the comments. When the selected webpage content on the display terminal device is clicked again, the comments may be folded up and the selected webpage content may be highlighted.

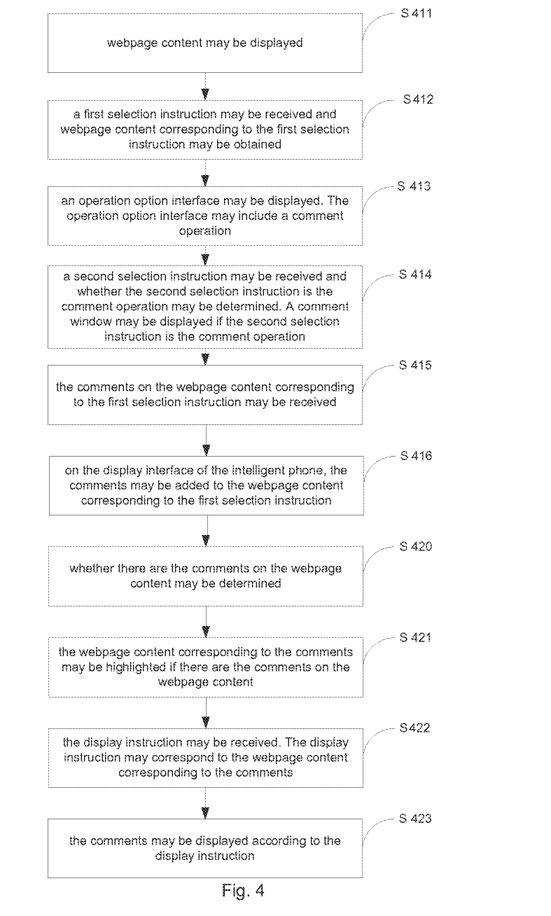

The device for adding the comments on the selected webpage content may be described hereinafter accompanying FIG. 6. The device may be set in a display terminal device. The device may include a second selection instruction receiving module M61 and a second comments receiving module M63. According to various embodiments, the device may further include a second selected content detection module M62 and a second comments displaying module M64.

The second selection instruction receiving module M61 may be set in the display terminal device and may be to receive a first selection instruction and obtain webpage content selected by the user according to the first selection instruction. If a sentence or a point of view on the webpage content is commented on, the webpage content corresponding to the sentence or the point of view need to be selected. The display terminal device may obtain the webpage content corresponding to the first selection instruction (i.e. the selected webpage content).

The second selected content detection module M62 may be to detect whether an operation for obtaining the selected webpage content is completed. The second selected content detection module M62 may automatically detect whether the operation for obtaining the selected webpage content is completed according to a built-in program. If the operation for obtaining the selected webpage content is not completed, the display terminal device may continue to receive the webpage content selected by the user. If the operation for obtaining the selected webpage content is finished, the display terminal device may send an instruction to the second comments receiving module M63.

The second comments receiving module M63 may further include a second operation option displaying module M631 and a second operation option receiving module M632.

The second operation option displaying module M631 may be to display an operation option interface. The operation option interface may include a comment operation. The second operation option displaying module M631 may be set in the display terminal device. The display terminal device may send the operation option interface to a scope of the selected webpage content. The operation option interface may be displayed on the display interface of the display terminal device in a form of an operation selection box. The operation options may include a copy operation, a search operation, and a comment operation. With the copy operation, the selected webpage content may be copied. With the search operation, the selected webpage content may be searched. With the comment operation, the selected webpage content may be commented.

The second operation option receiving module M632 may be set in the display terminal device and connect with the second operation option displaying module M631. The second operation option receiving module M632 may be to receive a second selection instruction and determine whether the received second selection instruction corresponds to the comment operation. If the second selection instruction corresponds to the comment operation, the comment window may be further displayed. The comment window may be used for receiving the comments. The display terminal device may receive the second selection instruction and determine whether the second selection instruction is the comment operation. If the second selection instruction is the comment operation, the display terminal device may send a comment request. If it is determined that the second selection instruction returned via the operation option interface is the comment operation, a comment window may be displayed on the display terminal device so that the user may comment on the selected webpage content.

The second comments receiving module M63 may be set in the display terminal device and may prompt the user to add the comments if the operation for obtaining the selected webpage content is completed and receive the comments made by the user on the selected webpage content. The comments may include any of the text comments, picture comments, and video comments. The picture comments may be Emoticons or appreciated gestures, etc. The video comments may be a video lasting several minutes. The comments may also be the combination of the text comments, the picture comments, and the video comments rendering the comments more animated.

The second comments displaying module M64 may be set in the display terminal device and connect with the second comments receiving module M63. The second comments displaying module M64 may be to display the webpage content corresponding to the comments. On the display interface of the display terminal device, the comments may be displayed in the sidebar (such as the comments). The comments may be displayed on the right of the selected webpage content, which does not affect the speed for viewing the webpage content. The comments may be relevantly visible and it may be easier to manage the comments.

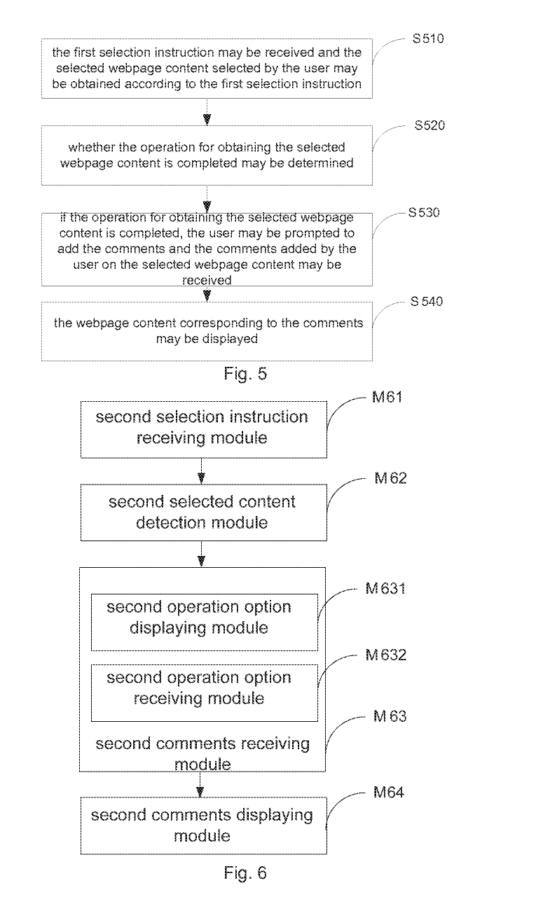

FIG. 7 is a diagram illustrating another device for displaying comments on webpage content according to various embodiments. FIG. 7 may include a memory 700 and a processor 701. The memory 700 may include a first webpage content highlighting instruction, a first display instruction receiving instruction, and a first comments displaying instruction. The processor 701 may communicate with the memory 700 and execute the first webpage content highlighting instruction, the first display instruction receiving instruction and the first comments displaying instruction to respectively execute the operations of the first webpage content highlighting module M221, the first display instruction receiving module M222, and the first comments displaying module M223.

The memory 700 may further include a first webpage content displaying instruction, a first selection instruction receiving instruction, a first operation option displaying instruction, a first operation instruction determination instruction, a first comments receiving instruction, a first comments adding instruction, and a first comments determination instruction.

The processor 701 may further execute the first webpage content displaying instruction, the first selection instruction receiving instruction, the first operation option displaying instruction, the first operation instruction determination instruction, the first comments receiving instruction, the first comments adding instruction and the first comments determination instruction to respectively execute the operations of the first webpage content displaying module M211, the first selection instruction receiving module M212, the first operation option displaying module M213, the first operation instruction determination module M214, the first comments receiving module M215, the first comments adding module M216, and the first comments determination module M220 mentioned above.

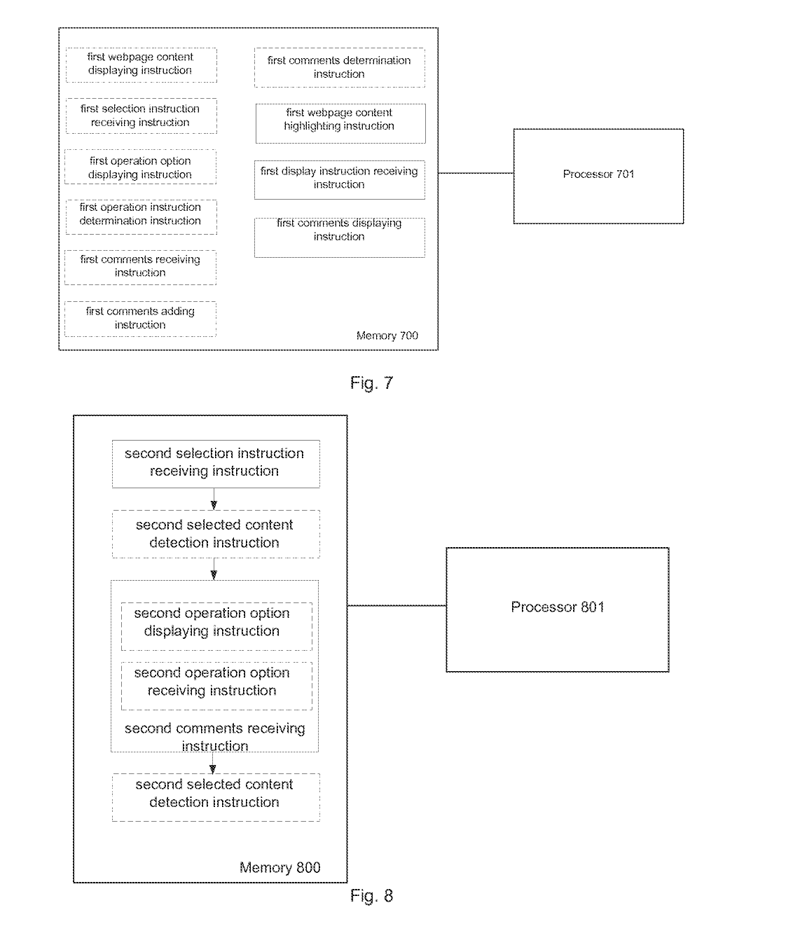

FIG. 8 is a diagram illustrating another device for adding comments to webpage content according to various embodiments. The device may include a memory 800 and a processor 801.

The memory 800 may include a second selection instruction receiving instruction and a second comments receiving instruction. The processor 801 may communicate with the memory 800 and execute the second selection instruction receiving instruction and the second comments receiving instruction to the operations of the second selection instruction receiving module M61 and the second comments receiving module M63, respectively.

According to various embodiments, the memory 800 may further include a second selected content detection instruction, a second comments displaying instruction, a second operation option displaying instruction, and a second operation option receiving instruction. The processor 801 may further execute the second selected content detection instruction, the second comments displaying instruction, the second operation option displaying instruction, and the second operation option receiving instruction to execute the operations of the second selected content detection module M62, the second comments displaying module M64, the second operation option displaying module M631, and the second operation option receiving module M632, respectively.

According to various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module mechanically, in dedicated and permanently configured circuitry, or in temporarily configured circuitry (e.g., configured by software) may be driven by cost and time considerations.

What has been described and illustrated herein are examples of the disclosure along with some variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for displaying a comment on webpage content, comprising:
highlighting webpage content corresponding to a comment;
receiving a display instruction; wherein the display instruction corresponds to the webpage content corresponding to the comment;
displaying the comment according to the display instruction.

2. The method according to claim 1, further comprising:
determining whether there is the comment on the webpage content;
wherein highlighting the webpage content corresponding to the comment comprises: upon a determination that the comment is on the webpage content, highlighting the webpage content corresponding to the comment.

3. The method according to claim 2, wherein before determining whether there is the comment on the webpage content, the method further comprises:
displaying the webpage content;
receiving a first selection instruction;
obtaining webpage content corresponding to the first selection instruction;
receiving a comment on the webpage content corresponding to the first selection instruction; and
adding the comment on the webpage content corresponding to the first selection instruction to the webpage content corresponding to the first selection instruction.

4. The method according to claim 3, wherein after receiving the first selection instruction and obtaining the webpage content corresponding to the first selection instruction, the method further comprises:
displaying an operation option interface; wherein the operation option interface comprises a comment operation;
receiving a second selection instruction;
determining whether the second selection instruction corresponds to the comment operation; and
if the second selection instruction corresponds to the comment operation, displaying a comment window; wherein the comment window is used for receiving the comment.

5. The method according to claim 1, wherein the comment comprises at least one of a text comment, a picture comment and a video comment.

6. The method according to claim 1, wherein highlighting the webpage content corresponding to the comment comprises: displaying an icon on a highlighted area, wherein the icon comprises a number of times that the webpage content corresponding to the comment is commented.

7. The method according to claim 3, wherein when the comment on the webpage content corresponding to the first selection instruction is added to the webpage content corresponding to the first selection instruction, the method further comprises: displaying the comment on the webpage content corresponding to the first selection instruction in a sidebar.

8. A method for adding a comment on webpage content, comprising:
receiving a first selection instruction;
obtaining webpage content corresponding to the first selection instruction;
prompting a user to add a comment on the webpage content corresponding to the first selection instruction;
receiving the comment made by the user on the webpage content corresponding to the first selection instruction; and
adding the comment to the webpage content corresponding to the first selection instruction.

9. The method according to claim 8, further comprising:
detecting whether an operation for obtaining the webpage content corresponding to the first selection instruction is completed;
wherein prompting the user to add the comment on the webpage content corresponding to the first selection instruction comprises: if the operation for obtaining the webpage content corresponding to the first selection instruction is completed, prompting the user to add the comment on the webpage content corresponding to the first selection instruction;
wherein the method further comprises:
displaying the comment on the webpage content corresponding to the first selection instruction; or
receiving a display instruction, displaying the comment on the webpage content corresponding to the first selection instruction according to the display instruction; wherein the display instruction corresponds to the webpage content corresponding to the comment.

10. The method according to claim 9, further comprising:
displaying an operation option interface; wherein the operation option interface comprises a comment operation;
receiving a second selection instruction;
determining whether the second selection instruction corresponds to the comment operation; and
if the second selection instruction corresponds to the comment operation, displaying a comment window; wherein the comment window is used for receiving the comment.

11. A device for displaying a comment on webpage content, comprising:
a first webpage content highlighting module, to highlight webpage content corresponding to a comment;
a first display instruction receiving module, receiving a display instruction;
wherein the display instruction corresponds to the webpage content corresponding to the comment; and
a first comments displaying module, to display the comment according to the display instruction.

12. The device according to claim 11, further comprising:
a first comments determination module, to determine whether there is the comment on webpage content;
wherein the first webpage content highlighting module is further to if there is the comment on the webpage content, highlight the webpage content corresponding to the comment.

13. The device according to claim 12, further comprising:
a first webpage content displaying module, to display the webpage content;
a first selection instruction receiving module, to receive a first selection instruction and obtain webpage content corresponding to the first selection instruction;
a first comments receiving module, to receive a comment on the webpage content corresponding to the first selection instruction; and
a first comments adding module, to add the comment on the webpage content corresponding to the first selection instruction to the webpage content corresponding to the first selection instruction.

14. The device according to claim 13, further comprising:
a first operation option displaying module, to display an operation option interface, wherein the operation option interface comprises a comment operation; and
a first operation instruction determination module, to receive a second selection instruction, determine whether the second selection instruction corresponds to the comment operation and if the second selection instruction corresponds the comment operation, display a comment window; wherein the comment window receives the comment.

15. The device according to claim 11, wherein the comment comprises at least one of a text comment, a picture comment and a video comment.

16. The device according to claim 11, wherein the first webpage content highlighting module is further to display an icon on a highlighted area, wherein the icon comprises a number of times that the webpage content corresponding to the comment is commented.

17. The device according to claim 13, wherein the first comments adding module is further to display the comment on the webpage content corresponding to the first selection instruction in a sidebar when the comment on the webpage content corresponding to the first selection instruction are added to the webpage content corresponding to the first selection instruction.
